(19) United States
(12) Patent Application Publication
(10) Pub. No.: US 2025/0320434 A1
(43) Pub. Date: Oct. 16, 2025

(54) TEXTILE WASHING METHOD

(71) Applicant: HENKEL AG & CO. KGAA, Düsseldorf (DE)

(72) Inventors: Arnd KESSLER, Monheim am Rhein (DE); Ingo HARDACKER, Hamminkeln (DE); Slavoljub BARACKOV, Monheim am Rhein (DE); Peter SCHMIEDEL, Düsseldorf (DE); Anna KLEMMER, Düsseldorf (DE)

(21) Appl. No.: 18/866,065

(22) PCT Filed: Feb. 21, 2023
(86) PCT No.: PCT/EP2023/054314

§ 371 Date: Nov. 14, 2024

(30) Foreign Application Priority Data
May 16, 2022 (DE) 10 2022 204 754.0

(51) Int. Cl. C11D 3/39; C11D 1/22; C11D 1/29; C11D 1/72; C11D 1/825; D06F 35/00

(52) U.S. Cl. CPC C11D 3/3945; C11D 1/825; D06F 35/005; C11D 1/22; C11D 1/29; C11D 1/72

(57) ABSTRACT

A method for washing textiles in a washing machine is described. A washing machine is provided with a wash program that includes a main wash cycle having a duration t_{w}. Textiles are introduced into a laundry treatment chamber of the washing machine. An aqueous liquor is introduced into the laundry treatment chamber of the washing machine. A first detergent composition including at least one surfactant is introduced into the laundry treatment chamber of the washing machine at a point in time of from 0 to 10% of the duration t_{w}. A second detergent composition including peroxycarboxylic acid and a second surfactant into the aqueous liquor at a point in time of from 11 to 99% of the duration t_{w}.

The present invention relates to a textile washing method. In particular, the application relates to a multi-stage machine textile washing method in the course of which washing and cleaning-active substances are metered in a staggered manner.

While less than one third of people in total currently have access to a textile washing machine, in some regions of the world machine textile cleaning has been the standard method for removing dirt and for refreshing laundry since the 1970s.

Both machine technology and the detergents used in machine cleaning methods for textiles have been continuously developed and improved with regard to their performance and ecological footprint in the past decades. Although development efforts were initially directed to the improvement of the individual components of the washing process, for example the textile washing machine and its mechanics and programs, or the textile detergent, interest has recently focused on the improvement in the interaction of these components.

In the international application WO 2021/048911 A1, a washing method is described using a textile washing machine, in the course of which the textiles are sprayed with a rinsing solution in a rinse cycle.

In European Patent EP 3 428 336 B1, washing methods with a minimum duration of 110 minutes are disclosed, in the course of which detergents containing rejuvenating agents are added to the washing liquid.

European Patent EP 2 711 413 B1 relates to washing methods that are characterized by a staggered metering of different washing-active substances.

European Patent EP 2 566 943 B1 discloses the sensor-controlled, staggered metering of washing-active substances, for example peroxycarboxylic acids, into the interior of a textile washing machine.

Against the background of the previous developments, there is also the technical object of improving the washing performance of textile detergents in textile washing machines.

To achieve this object, a method for washing textiles in a household washing machine having the following steps is suitable:
a) providing a washing machine with a wash program, including a main wash cycle with the duration t_{w}, and activating said wash program;
b) introducing textiles into the laundry treatment chamber of the washing machine;
c) introducing an aqueous liquor into the laundry treatment chamber of the washing machine;
d) introducing a first detergent composition, comprising at least one surfactant, into the laundry treatment chamber of the washing machine during the main wash cycle at a point in time of 0 to 10% t_{w};
e) introducing a second detergent composition, comprising peroxycarboxylic acid and surfactant, into the aqueous liquor of the main wash cycle at a point in time of 11 to 99% t_{w}.

A motor-driven device for cleaning textiles is referred to as a washing machine. Particularly preferred are rotary washing machines with an inner tub rotatable about a horizontal axis. The method according to the invention is suitable in particular for carrying out in a household washing machine with an outer tub, an inner tub attached within the outer tub, as a laundry treatment chamber, and a pumping device that is configured to pump aqueous liquor out of the outer tub.

In step a) of the method, a washing machine with a wash program, including a main wash cycle with the duration t_{w}, is provided. Conventional washing machines usually have a plurality of wash programs provided for cleaning different textiles, which wash programs can have, in addition to a main wash cycle, pre-rinse, rinse and/or spin cycles. Preferred wash programs comprise a main wash cycle, at least one rinse cycle and at least one spin cycle. Alternative wash programs have at least one pre-wash cycle, a main wash cycle, at least one rinse cycle, and at least one spin cycle.

In addition to the mechanical forces acting on the laundry, the detergent used and the liquor temperature reached in the washing liquor, the duration of the wash cycle, in particular of the main wash cycle, has an influence on the cleaning performance achieved. The duration t_{w} of the main wash cycle used in the washing method is preferably 15 to 400 minutes, preferably 30 to 240 minutes, and in particular 60 to 180 minutes.

The textiles introduced into the laundry treatment chamber in step b) can be, for example, cotton or synthetic textiles, but also mixed fabrics.

The aqueous liquor introduced into the laundry treatment chamber in step c) preferably has a volume of 3 to 40 l, preferably 6 to 30 l, and in particular 8 to 20 l.

The loading of the washing machine with textiles in step b) and the volume of the aqueous liquor introduced in step c) are preferably coordinated with one another in such a way that the weight ratio of aqueous liquor to textiles in step c) is above 1:1, preferably above 2:1, and in particular above 5:2.

The aqueous liquor preferably has a temperature T₁ of 18 to 25° C. in step c).

The first detergent composition is introduced into the laundry treatment chamber at a point in time of 0 to 10% t_{w} in step d). In other words, the first detergent composition is already located in the laundry treatment chamber at the start of the main wash cycle (point in time of 0 t_{w}) or is introduced into the laundry treatment chamber within a period of 10% of the duration t_{w} of the main wash cycle.

In a first method variant, the aqueous liquor is introduced into the laundry treatment chamber of the washing machine before the first detergent composition. Such a method variant can be realized, for example, by means of a pre-rinse cycle, in the course of which the textiles are pre-rinsed and/or soaked with water but not yet cleaned by means of the actual detergent composition.

A second method variant provides the simultaneous introduction of the aqueous liquor and the first detergent composition into the laundry treatment chamber of the washing machine. If the aqueous liquor is conducted into the laundry treatment chamber without a pre-rinse cycle, for example through the washing machine dispensing drawer filled with the first detergent composition, the aqueous liquor and the first detergent composition are introduced into the laundry treatment chamber simultaneously.

Finally, it is also possible for the aqueous liquor to be introduced into the laundry treatment chamber of the washing machine after the first detergent composition, for example by applying the first detergent composition directly to the textiles in pre-portioned form or by means of a metering aid before the start of the wash program.

The first detergent composition introduced into the laundry treatment chamber preferably comprises at least one anionic surfactant. Preferred first detergent compositions contain, based on their total weight, 12 to 40 wt. %, preferably 15 to 30 wt. %, and in particular 18 to 25 wt. % anionic surfactant.

The anionic surfactant is preferably selected from the group comprising C₉-C₁₃ alkylbenzene sulfonates, olefin sulfonates, C₁₂-C₁₈ alkane sulfonates, ester sulfonates, alk(en)yl sulfates, fatty alcohol ether sulfates and mixtures thereof. Compositions which comprise C₉-C₁₃ alkylbenzene sulfonates and fatty alcohol ether sulfates as the anionic surfactant have particularly good dispersing properties. In this case, preferably C₉-C₁₃ alkylbenzene sulfonates, olefin sulfonates, i.e. mixtures of alkene and hydroxyalkane sulfonates, and disulfonates, as obtained, for example, from C₁₂-C₁₈ monoolefins having a terminal or internal double bond by way of sulfonation with gaseous sulfur trioxide and subsequent alkaline or acid hydrolysis of the sulfonation products, are possible as surfactants of the sulfonate type. C₁₂-C₁₈ alkane sulfonates and the esters of α-sulfo fatty acids (ester sulfonates) are also suitable, for example the α-sulfonated methyl esters of hydrogenated coconut, palm kernel or tallow fatty acids.

It is very particularly preferred for the first detergent composition to contain at least one anionic surfactant of formula (I),

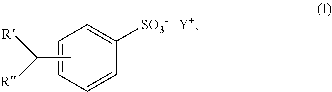

where
R′ and R″ are, independently of one another, H or alkyl, and together contain 9 to 19, preferably 9 to 15 and in particular 9 to 13, C atoms, and Y⁺ denotes a monovalent cation or the nth part of an n-valent cation (in particular monoethanolamine).

The group of the alkyl ether sulfates includes the fatty alcohol ether sulfates, for example the sulfuric acid monoesters of the straight-chain or branched C₇-C₂₁ alcohols ethoxylated with 1 to 6 mol ethylene oxide, such as 2-methyl-branched C₉₋₁₁ alcohols having, on average, 3.5 mol ethylene oxide (EO) or C₁₂₁₈ fatty alcohols having 1 to 4 EO. Alkyl ether sulfates of formula (II) are preferred

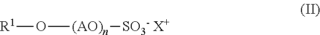

In this formula (II), R¹ is a linear or branched, substituted or unsubstituted alkyl functional group, preferably a linear, unsubstituted alkyl functional group, particularly preferably a fatty alcohol functional group. Preferred R¹ functional groups of formula (II) are selected from decyl, undecyl, dodecyl, tridecyl, tetradecyl, pentadecyl, hexadecyl, heptadecyl, octadecyl, nonadecyl, eicosyl functional groups and the mixtures thereof, the representatives having an even number of C atoms being preferred. Particularly preferred functional groups R¹ of formula (II) are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.

AO in formula (II) represents an ethylene oxide (EO) or propylene oxide (PO) group, preferably an ethylene oxide group. The index n in formula (I) is an integer from 1 to 50, preferably from 1 to 20, and in particular from 2 to 10. Very particularly preferably, n is 2, 3, 4, 5, 6, 7 or 8. X is a monovalent cation or the nth part of an n-valent cation, the alkali metal ions, including Na⁺ or K⁺, being preferred in this case, with Na⁺ being most preferred. Further cations X+ may be selected from NH₄⁺, ½ Zn²⁺,½ Mg²⁺,½ Ca²⁺, ½ Mn²⁺ and the mixtures thereof, as well as primary and secondary amines, in particular monoethanolamine.

Particularly preferred first detergent compositions contain an alkyl ether sulfate selected from fatty alcohol ether sulfates of formula (III)

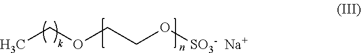

where k=11 to 19, and n=2, 3, 4, 5, 6, 7 or 8. Very particularly preferred representatives are Na fatty alcohol ether sulfates having 12 to 18 C atoms and 2 EO (k=11 to 13, n=2 in formula III). The degree of ethoxylation indicated represents a statistical average that can correspond to an integer or a fractional number for a specific product. The degrees of alkoxylation indicated represent statistical averages which can be an integer or a fractional number for a specific product. Preferred alkoxylates/ethoxylates have a narrowed homolog distribution (narrow range ethoxylates, NRE).

In summary, preferred first detergent compositions contain, based on their total weight, 12 to 40 wt. %, preferably 15 to 30 wt. %, and in particular 18 to 25 wt. %, anionic surfactant from the group of the C₉₋₁₉ alkylbenzene sulfonates and alkyl ether sulfates, preferably from the group of the C₉₋₁₉ alkylbenzene sulfonates.

The use of fatty acids has proven advantageous for stability and cleaning performance. Preferred first detergent compositions therefore contain, based on their total weight, 4 to 12 wt. %, preferably 6 to 10 wt. %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are not assigned to the group of anionic surfactants.

As a further preferred component, the first detergent composition comprises at least one non-ionic surfactant.

Particularly preferred is the use of non-ionic surfactants from the group of alkyl ethoxylates, preferred alkyl ethoxylates being selected from the group of the ethoxylated primary C₆₋₁₈ alcohols, preferably the ethoxylated primary C₈₋₁₈ alcohols having a degree of alkoxylation≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

Preferred first detergent compositions contain, based on their total weight, 12 to 40 wt. %, preferably 15 to 30 wt. %, and in particular 18 to 25 wt. %, non-ionic surfactant from the group of the ethoxylated primary C₈₋₁₈ alcohols, preferably the ethoxylated primary C₈₋₁₈ alcohols having a degree of alkoxylation≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

As a further preferred optional component, the first detergent composition comprises at least one enzyme preparation, preferably at least three enzyme preparations of enzymes from the group of lipase, amylase, protease, cellulase, mannanase, and hexosaminidase. Due to their improved cleaning effect, first detergent compositions that contain, based on their total weight, 2 to 8 wt. %, preferably 3 to 6 wt. %, enzyme preparation are preferred.

According to the invention, it is preferred if the first detergent composition contains at least one lipase preparation. Lipases preferred according to the invention are selected from at least one enzyme of the group formed from triacylglycerol lipase (E.C. 3.1.1.3), and lipoprotein lipase (E.C. 3.1.1.34), and monoglyceride lipase (E.C. 3.1.1.23).

Preferred lipase preparations according to the invention are the commercial products marketed by Amano Pharmaceuticals under the names Lipase M-AP10®, Lipase LE® and Lipase FR (also Lipase JV®). For example, Lipase F is naturally present in Rhizopus oryzae. Lipase M-AP100, for example, is naturally present in Mucor javanicus.

The first detergent composition preferably contains at least one amylase, in particular an α-amylase. α-amylases (E.C. 3.2.1.1) as enzymes hydrolyze internal xx-1,4-glycosidic bonds of starch and starch-like polymers. Examples that can be mentioned are the x-amylases from Bacillus licheniformis, from B. amyloliquefaciens and from B. stearothermophilus, as well as the developments thereof that have been improved for use in detergents or cleaning agents. The enzyme from B. licheniformis is available from Novozymes under the trade name Termamyl® and from Genencor under the trade name Purastar®ST. Development products of these x-amylases are available from Novozymes under the trade names Duramyl® and Termamyl®ultra, from Genencor under the name Purastar®OxAm, and from Daiwa Seiko Inc., Tokyo, Japan, as Keistase®. The x-amylase from B. amyloliquefaciens is marketed by Novozymes under the name BAN®, and derived variants of the x-amylase from B. stearothermophilus are marketed under the names BSG® and Novamyl®, also by Novozymes. Examples of x-amylases from other organisms are the developments of α-amylase from Aspergillus niger and A. oryzae that are available under the trade name Fungamyl® from Novozymes.

It is preferred according to the invention if the first detergent composition contains at least one protease as enzyme. A protease is an enzyme that cleaves peptide bonds by hydrolysis. Each of the enzymes from class E.C. 3.4 according to the invention falls thereunder (comprising each of the thirteen subclasses which fall thereunder). According to the invention, “protease activity” is present if the enzyme has proteolytic activity (EC 3.4). Different types of protease-activity are known: The three main types are: trypsin-like, where the amide substrate is cleaved following the amino acids Arg or Lys at P1; chymotrypsin-like, where cleavage takes place following one of the hydrophobic amino acids at P1; and elastase-like, where the amide substrate is cleaved following Ala at P1.

As a further preferred optional component, the first detergent composition contains a cellulase preparation. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucanhydrolase, celludextrinase or avicelase. Within the meaning of the invention, whether or not an enzyme is a cellulase is decided by its ability to hydrolyze 1,4-β-D-glucosidic bonds in cellulose.

Cellulases (endoglucanases, EG) suitable according to the invention include, for example, fungal compositions rich in endoglucanase (EG), which are provided by the company Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, Finland, under the trade names Ecostone® and Biotouch®, and which are, at least in part, based on 20 kD-EG from Melanocarpus. Further cellulases from AB Enzymes are Econase® and Ecopulp®. Further suitable cellulases are from Bacillus sp. CBS 670.93 and CBS 669.93, wherein the cellulase from Bacillus sp. CBS 670.93 is available from Danisco/Genencor under the trade name Puradax®. Other commercial products from Danisco/Genencor that can be used are “Genencor detergent cellulase L” and IndiAge®Neutra.

As a preferred component, the first detergent composition contains a mannanase preparation.

A mannanase catalyzes the hydrolysis of 1,4-beta-D-mannosidic bonds in mannans, galactomannans, glucomannans and galactoglucomannans. Said mannanases are classified according to the enzyme nomenclature as E.C. 3.2.1.78.

The term “hexosaminidase” denotes a polypeptide with hexosaminidase activity (hexosaminidases) and includes enzymes which catalyze the hydrolysis of N-acetyl-D-hexosamine-or N-acetylglucosamine polymers.

Polypeptides with hexosaminidase activity include dispersins, such as Dispersin B (DspB), which are β-N-acetylglucosamininidases belonging to the glycoside hydrolase 20 family. Dispersins are produced by the parodontal pathogen Aggregatibacter actinomycetemcomitans, a gram-negative oral bacterium. Dispersin B is a 3-hexosaminidase, which specifically hydrolyzes β-1,6-glycosidic bonds of acetylglucosamine polymers. The use of hexosaminidases from the group of β-hexosaminidases is preferred.

In addition to the actual enzyme protein, an enzyme preparation comprises further components, such as enzyme stabilizers, carrier materials or fillers. In this case, the enzyme protein typically forms only a fraction of the total weight of the enzyme preparation. Enzyme preparations which are preferably used contain between 0.1 and 40 wt. %, preferably between 0.2 and 30 wt. %, more preferably between 0.4 and 20 wt. %, and most preferably between 0.8 and 10 wt. % of the enzyme protein. In such compositions, an enzyme stabilizer can be contained in an amount of 0.05 to 35 wt. %, preferably 0.05 to 10 wt. %, based on the total weight in the enzyme composition.

The protein concentration can be determined using known methods, for example the BCA method (bicinchoninic acid; 2,2′-bichinolyl-4,4′-dicarboxylic acid) or the Biuret method. The active protein concentration is determined in this regard via titration of the active centers a suitable using irreversible inhibitor (for proteases, for example, phenylmethylsulfonylfluoride (PMSF)), and determination of the residual activity.

In a method variant, the first detergent composition is preferably introduced into the laundry treatment chamber of the washing machine at a point in time of 0 t_{w} in step d).

More preferably, the first detergent composition is introduced into the laundry treatment chamber of the washing machine at a point in time of >0 to 10% t_{w}, preferably >0 to 5% t_{w}, in step d).

In contrast, the peroxycarboxylic acid and the surfactant of the second detergent composition are introduced into the aqueous liquor at a point in time of 30 to 99% t_{w}, preferably at a point in time of 50 to 99% t_{w}, particularly preferably at a point in time of 70 to 99% t_{w}, and in particular at a point in time of 80 to 96 t_{w} in step e).

The term “second detergent composition” comprises all the active substances that are introduced into the aqueous liquor at a point in time of 11 to 99% t_{w}, preferably at a point in time of 30 to 99% t_{w}, particularly preferably at a point in time of 50 to 99% t_{w}, very particularly preferably at a point in time of 70 to 99% t_{w}, and in particular preferably at a point in time of 80 to 96 t_{w}. The components of the second detergent composition can pass into the aqueous liquor simultaneously, but also in a staggered manner. It is particularly preferred if the peroxycarboxylic acid and the surfactant as essential constituents of the second detergent composition are introduced into the aqueous liquor within a period of five minutes, particularly preferably of 2 minutes and in particular of 1 minute.

In step e) of the method, a peroxycarboxylic acid is introduced into the aqueous liquor. Preferred peroxycarboxylic acids are in particular
i) mono- and diperoxycarboxylic acids, such as performic acid, peracetic acid, decanedioic acid, dodecanedioic acid,
ii) mono- and diperphthalic acids,
iii) mono- and diperterephthalic acids,
iv) imidoperoxycarboxylic acids, such as 6-phthalimidoperoxycaproic acid (PAP).

The peroxycarboxylic acid is preferably solid at room temperature and atmospheric pressure; in this case, the peroxycarboxylic acid is used as a preferably water-containing suspension or dispersion. The use of 6-phthalimidoperoxycaproic acid (PAP) is particularly preferred.

In step e), the peroxycarboxylic acid is preferably introduced into the washing liquor in the form of a preparation having a proportion by weight of 5 to 45 wt. %, preferably 10 to 30 wt. % peroxycarboxylic acid. The proportion by weight of the peroxycarboxylic acid with respect to the total weight of the second detergent composition is preferably 4 to 25 wt. %, particularly preferably 6 to 20 wt. %, and in particular 8 to 15 wt. %.

The surfactant introduced into the aqueous liquor in step e) can be identical to or different from the surfactant present in the first detergent composition. The use of identical surfactant reduces the formulation complexity, while the use of a surfactant of a different structure enriches the aqueous liquor by an active substance with cleaning profile differing from the active substances hitherto present in the liquor. For the latter reason, it is preferred if the surfactant introduced in step e) differs from the surfactant introduced in step d).

The proportion by weight of the surfactant, preferably the non-ionic surfactant, with respect to the total weight of the second detergent composition is preferably 10 to 70 wt. %, particularly preferably 20 to 65 wt. %, and in particular 30 to 60 wt. %.

The surfactant in step e) is preferably selected from the group of non-ionic surfactants, in particular the non-ionic surfactants from the group of the alkoxylated primary C₈₋₁₈ alcohols, preferably from the group of the ethoxylated primary C₈₋₁₈ alcohols having a degree of ethoxylation≥4 and the ethoxylated and propoxylated C₈₋₁₈ alcohols having a degree of ethoxylation≥4 and a degree of propoxylation≥2, particularly preferably from the group of the ethoxylated primary C₁₂₋₁₄ alcohols having a degree of ethoxylation≥6 and the ethoxylated and propoxylated C₁₆₋₁₈ alcohols having a degree of ethoxylation≥4 and a degree of propoxylation≥2.

Particular preference is given to washing methods in which the surfactant in step e) is selected from the group of the non-ionic surfactants of general formula CH₃(CH₂)ₙOEOₓPO_{y} where n=5 to 21, x=2 to 10, and y=2 to 10, wherein non-ionic surfactants of general formula CH₃(CH₂)ₙOEOₓPO_{y}, where n=15 to 17, x=4 to 8, and y=2 to 6, are very particularly preferred.

Also particularly preferred in step e) is the use of non-ionic surfactants from the group of the ethoxylated primary C₈₋₁₈ alcohols having a degree of ethoxylation≥4, in particular from the group of the ethoxylated primary C₁₀₋₁₄ alcohols having a degree of ethoxylation of 6 to 10.

Alternatively, but preferably in combination with the aforementioned non-ionic surfactants, a surfactant is used in step e) that is selected from the group of amine oxides, preferably from the group of the alkylamine oxides, in particular alkyldimethylamine oxides, alkylamidoamine oxides and alkoxyalkylamine oxides, particularly preferably from the group of amine oxides of formula (Ia) or (Ib)

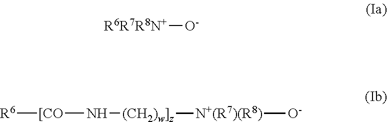

in which R⁶ is a saturated or unsaturated C₆₋₂₂ alkyl group, preferably a C₈₋₁₈ alkyl group, in particular a saturated C₁₀₋₁₆ alkyl group, for example a saturated C₁₂₋₁₄ alkyl group, which is bound to the nitrogen atom N in the alkylamidoamine oxides via a carbonyl amido alkylene group-CO—NH—(CH₂)_{z}— and in the alkoxyalkylamine oxides via an oxaalkylene group-O—(CH₂)_{z}—, where z in each case stands for a number from 1 to 10, preferably 2 to 5, in particular 3,
R⁷ and R⁸ are, independently of one another, a C₁₋₄ alkyl group, which is optionally hydroxy-substituted, such as a hydroxyethyl group, in particular a methyl group.

It is very particularly preferred to use surfactants in step e) that are selected from the group of amine oxides, in particular from the group cocoalkyl dimethylamine oxide, myristyl dimethylamine oxide, cetyl dimethylamine oxide, lauryl dimethylamine oxide, and stearyl dimethylamine oxide.

The use of the aforementioned surfactants from the group of non-ionic surfactants and amphoteric surfactants has proven to be advantageous for the cleaning performance achieved in the washing method.

For the cleaning performance achieved, it has also proven to be advantageous if the peroxycarboxylic acid and the surfactant are introduced into the aqueous liquor in a weight ratio of 2:1 to 1:12, preferably 3:2 to 1:10, and in particular 1:1 to 1:8 in step e).

In a preferred method variant, a polyalkoxylated polyalkylene imine obtained by reacting polyalkylene imines with alkylene oxides is introduced into the aqueous liquor in step e).

The polyalkoxylated polyalkylene imine is a polymer having a polyalkylene imine backbone which carries polyalkoxy groups on the N atoms. It preferably has a weight-average molecular weight Mw in the range from 5000 g/mol to 60000 g/mol, in particular from 10000 g/mol to 22500 g/mol. The polyalkylene imine has primary amino functions at the ends and preferably both secondary and tertiary amino functions in the interior, and optionally it can also have only secondary amino functions in the interior such that the result is not a branched-chain but a linear polyalkylene imine. The ratio of primary to secondary amino groups in the polyalkylene imine is preferably in the range from 1:0.5 to 1:1.5, in particular in the range from 1:0.7 to 1:1. The ratio of primary to tertiary amino groups in the polyalkylene imine is preferably in the range from 1:0.2 to 1:1, in particular in the range from 1:0.5 to 1:0.8. The polyalkylene imine preferably has a weight-average molecular weight in the range from 500 g/mol to 50000 g/mol, in particular from 550 g/mol to 2000 g/mol. The N atoms in the polyalkylene imine are preferably separated from one another by alkylene groups having 2 to 12 C atoms, in particular 2 to 6 C atoms, although it is not necessary for all the alkylene groups to have the same number of C atoms. Ethylene groups, 1,2-propylene groups, 1,3-propylene groups and mixtures thereof are particularly preferred. The primary amino functions in the polyalkylene imine can carry 1 or 2 polyalkoxy groups and the secondary amino functions can carry 1 polyalkoxy group, not every amino function having to be alkoxy group-substituted. The average number of alkoxy groups per primary and secondary amino function in the polyalkoxylated polyalkylenimine is preferably 5 to 100, in particular 10 to 50. The alkoxy groups in the polyalkoxylated polyalkylene imine are preferably ethoxy, propoxy or butoxy groups or mixtures thereof. Polyethoxylated polyethyleneimines are particularly preferred. The polyalkoxylated polyalkylene imines are obtainable by reacting the polyalkylene imines with epoxides corresponding to the alkoxy groups. If desired, the terminal OH function of at least some of the polyalkoxy substituents can be replaced by an alkyl ether function having 1 to 10, in particular 1 to 3, C atoms. The polyalkoxylated polyalkylene imine can be partially quaternized.

The composition of some preferred first and second detergent compositions for use in the method according to the invention can be found in the following tables (amounts given in wt. % based on the total weight of the solid gel or the casing substance, unless otherwise indicated).

| Formula | Formula | Formula | Formula |
|---|---|---|---|
| 1 | 2 | 3 | 4 |

First detergent composition

| | | | | |
|---|---|---|---|---|
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| Peroxycarboxylic | 4 to 25 | 6 to 20 | 6 to 20 | 8 to 15 |
|---|---|---|---|---|
| acid | | | | |
| Surfactant | 10 to 70 | 20 to 65 | 30 to 60 | 30 to 60 |
| | Formula | Formula | Formula | Formula |
| | 5 | 6 | 7 | 8 |

First detergent composition

| | | | | |
|---|---|---|---|---|
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| 6-Phthalimido- | 4 to 25 | 6 to 20 | 6 to 20 | 8 to 15 |
|---|---|---|---|---|
| peroxycaproic | | | | |
| acid (PAP) | | | | |
| Surfactant | 10 to 70 | 20 to 65 | 30 to 60 | 30 to 60 |
| | Formula | Formula | Formula | Formula |
| | 11 | 12 | 13 | 14 |

First detergent composition

| | | | | |
|---|---|---|---|---|
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| Peroxycarboxylic | 4 to 25 | 6 to 20 | 6 to 20 | 8 to 15 |
|---|---|---|---|---|
| acid | | | | |
| Non-ionic | 10 to 70 | 20 to 65 | 30 to 60 | 30 to 60 |
| surfactant* | | | | |
| | Formula | Formula | Formula | Formula |
| | 15 | 16 | 17 | 18 |

First detergent composition

| | | | | |
|---|---|---|---|---|
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| | | | | |
|---|---|---|---|---|
| 6-Phthalimido- | 4 to 25 | 6 to 20 | 6 to 20 | 8 to 15 |
| peroxycaproic | | | | |
| acid (PAP) | | | | |
| Non-ionic | 10 to 70 | 20 to 65 | 30 to 60 | 30 to 60 |
| surfactant* | | | | |

| | | | |
|---|---|---|---|
| Formula | Formula | Formula | Formula |
| 21 | 22 | 23 | 24 |

First detergent composition

| | | | | |
|---|---|---|---|---|
| Anionic surfactant | 12 to 40 | 15 to 30 | 15 to 30 | 18 to 25 |
| Non-ionic surfactant 1 | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| Peroxycarboxylic | 4 to 25 | 6 to 20 | 6 to 20 | 8 to 15 |
|---|---|---|---|---|
| acid | | | | |
| Non-ionic | 10 to 70 | 20 to 65 | 30 to 60 | 30 to 60 |
| surfactant 2** | | | | |
| | Formula | Formula | Formula | Formula |
| | 25 | 26 | 27 | 28 |

First detergent composition

| | | | | |
|---|---|---|---|---|
| Anionic surfactant | 12 to 40 | 15 to 30 | 15 to 30 | 18 to 25 |
| Non-ionic surfactant 1 | 12 to 40 | 15 to 30 | 15 to 30 | 18 to 25 |
| Enzyme preparation | 2 to 8 | 2 to 8 | 3 to 6 | 3 to 6 |
| Misc. | up to 100 | up to 100 | up to 100 | up to 100 |

Second detergent composition

| | | | | |
|---|---|---|---|---|
| 6-Phthalimido- | 4 to 25 | 6 to 20 | 6 to 20 | 8 to 15 |
| peroxycaproic | | | | |
| acid (PAP) | | | | |
| Non-ionic | 10 to 70 | 20 to 65 | 30 to 60 | 30 to 60 |
| surfactant 2** | | | | |

*ethoxylated and propoxylated C₈₋₁₈ alcohol having a degree of ethoxylation ≥ 4 and a degree of propoxylation ≥ 2
**non-ionic surfactant 2 differs from non-ionic surfactant 1 and is selected from the group of the ethoxylated and propoxylated C₈₋₁₈ alcohols having a degree of ethoxylation ≥ 4 and a degree of propoxylation ≥ 2

In step e), the peroxycarboxylic acid and the surfactant can be introduced into the aqueous liquor simultaneously or in a staggered manner, wherein the simultaneous introduction of peroxycarboxylic acid and surfactant into the aqueous liquor has proven to be particularly advantageous for the cleaning effect. For this reason, it is also preferred, for example, to introduce the peroxycarboxylic acid and the surfactant into the aqueous liquor in the form of a mixture in step e).

In step e), a phosphonate is also introduced as a preferred optional active substance into the aqueous liquor, wherein the weight ratio of peroxycarboxylic acid to phosphonate is preferably 1:2 to 1:20, in particular 1:4 to 1:12. Again, it is preferred to introduce the peroxycarboxylic acid and the phosphonate into the aqueous liquor simultaneously in step e).

Preferably, no water softeners from the group of the polymeric builders, complexing agents, and sequestering agents are introduced into the aqueous liquor in step e) of the washing method.

The temperature T₂ of the aqueous liquor is preferably 26 to 45° C. in step e). After introduction of the peroxycarboxylic acid, a pH of 7 to 9, in particular 7.5 to 8.5, is preferably established in the aqueous liquor.

After completion of the main wash cycle at the point in time of 100% t_{w}, the aqueous liquor is preferably pumped out of the laundry treatment chamber.

This application provides, inter alia, the following subjects:
1. A method for washing textiles in a household washing machine, comprising the steps of
a) providing a washing machine with a wash program, including a main wash cycle with the duration t_{w};
b) introducing textiles into the laundry treatment chamber of the washing machine;
c) introducing an aqueous liquor into the laundry treatment chamber of the washing machine;
d) introducing a first detergent composition, comprising at least one surfactant, into the laundry treatment chamber of the washing machine during the main wash cycle at a point in time of 0 to 10% t_{w};
e) introducing a second detergent composition, comprising peroxycarboxylic acid and surfactant, into the aqueous liquor of the main wash cycle at a point in time of 11 to 99% t_{w}.
2. The washing method according to point 1, wherein the household washing machine comprises an outer tub, an inner tub attached within the outer tub, as a laundry treatment chamber, and a pumping device that is configured to pump aqueous liquor out of the outer tub.
3. The washing method according to one of the preceding points, wherein the wash program comprises a main wash cycle, at least one rinse cycle, and at least one spin cycle.
4. The washing method according to one of the preceding points, wherein the wash program comprises at least one pre-wash cycle, a main wash cycle, an at least rinse cycle, and an at least spin cycle.
5. The washing method according to one of the preceding points, wherein the duration t_{w} of the main wash cycle is 15 to 400 minutes, preferably 30 to 240 minutes, and in particular 60 to 180 minutes.
6. The washing method according to one of the preceding points, wherein the aqueous liquor in step c) has a volume of 3 to 40 l, preferably of 6 to 30 l, and in particular of 8 to 20 l.
7. The washing method according to one of the preceding points, wherein the weight ratio of aqueous liquor to textiles in step c) is above 1:1, preferably above 2:1, and in particular above 5:2.
8. The washing method according to one of the preceding points, wherein the aqueous liquor in step c) has a temperature T₁ of 18 to 25° C.
9. The washing method according to one of the preceding points, wherein the aqueous liquor is introduced into the laundry treatment chamber of the washing machine before the first detergent composition.
10. The washing method according to one of the preceding points, wherein the aqueous liquor is introduced simultaneously with the first detergent composition into the laundry treatment chamber of the washing machine.
11. The washing method according to one of the preceding points, wherein the aqueous liquor is introduced into the laundry treatment chamber of the washing machine after the first detergent composition.
12. The washing method according to one of the preceding points, wherein the first detergent composition comprises at least one anionic surfactant.
13. The washing method according to one of the preceding points, wherein the first detergent composition comprises at least one anionic surfactant selected from the group of the C₉₋₁₃ alkylbenzene sulfonates, olefin sulfonates, C₁₂₋₁₈ alkane sulfonates, ester sulfonates, alk(en)yl sulfates, and fatty alcohol ether sulfates.
14. The washing method according to one of the preceding points, wherein the first detergent composition comprises at least one non-ionic surfactant.
15. The washing method according to one of the preceding points, wherein the first detergent composition contains at least one non-ionic surfactant selected from the group of the ethoxylated primary C₆₋₁₈ alcohols, preferably the ethoxylated primary C₈₋₁₈ alcohols having a degree of alkoxylation≥2, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.
16. The washing method according to one of the preceding points, wherein the first detergent composition comprises at least one enzyme preparation, preferably at least three enzyme preparations of enzymes from the group of lipase, amylase, protease, cellulase, mannanase and hexosaminidase.
17. The washing method according to one of the preceding points, wherein the first detergent composition is introduced into the laundry treatment chamber of the washing machine at a point in time of 0 t_{w} in step d).
18. The washing method according to one of the preceding points, wherein the first detergent composition is introduced into the laundry treatment chamber of the washing machine at a point in time of >0 to 10% t_{w}, preferably >0 to 5% t_{w}, in step d).
19. The washing method according to one of the preceding points, wherein the peroxycarboxylic acid in step e) is selected from the group of
i) the mono- and diperoxycarboxylic acids, such as performic acid, peracetic acid, decanedioic acid, dodecanedioic acid,
ii) the mono- and diperphthalic acids,
iii) the mono- and diperterephthalic acids,
iv) the imidoperoxycarboxylic acids, such as 6-phthalimidoperoxycaproic acid (PAP).
20. The washing method according to one of the preceding points, wherein the peroxycarboxylic acid in step e) is selected from the group 6-phthalimidoperoxycaproic acid (PAP).
21. The washing method according to one of the preceding points, wherein the peroxycarboxylic acid is introduced into the washing liquor in the form of a preparation having a proportion by weight of 5 to 45 wt. %, preferably 10 to 30 wt. % peroxycarboxylic acid in step e).
22. The washing method according to one of the preceding points, wherein the proportion by weight of the peroxycarboxylic acid with respect to the total weight of the second detergent composition is 4 to 25 wt. %, preferably 6 to 20 wt. %, and in particular 8 to 15 wt. %.
23. The washing method according to one of the preceding points, wherein the surfactant introduced in step e) differs from the surfactant introduced in step d).
24. The washing method according to one of the preceding points, wherein the proportion by weight of the surfactant with respect to the total weight of the second detergent composition is 10 to 70 wt. %, preferably 20 to 65 wt. %, and in particular 30 to 60 wt. %.
25. The washing method according to one of the preceding points, wherein the surfactant in step e) is selected from the group of the non-ionic surfactants, in particular the non-ionic surfactants from the group of the alkoxylated primary C₈₋₁₈ alcohols, preferably from the group of the ethoxylated primary C₈₋₁₈ alcohols having a degree of ethoxylation≥4 and the ethoxylated and propoxylated C₈₋₁₈ alcohols having a degree of ethoxylation≥4 and a degree of propoxylation≥2, particularly preferably from the group of the ethoxylated primary C₁₂₋₁₄ alcohols having a degree of ethoxylation≥6 and the ethoxylated and propoxylated C₁₆₋₁₈ alcohols having a degree of ethoxylation≥4 and a degree of propoxylation≥2.
26. The washing method according to one of the preceding points, wherein the surfactant in step e) is selected from the group of the non-ionic surfactants of general formula CH₃(CH₂)ₙOEOₓPO_{y}, where n=5 to 21, x=2 to 10, and y=2 to 10.
27. The washing method according to one of the preceding points, wherein the surfactant in step e) is selected from the group of the non-ionic surfactants of general formula CH₃(CH₂)ₙOEOₓPO_{y}, where n=15 to 17, x=4 to 8, and y=2 to 6.
28. The washing method according to one of the preceding points, wherein the surfactant in step e) is selected from the group of amine oxides, preferably from the group of the alkylamine oxides, in particular alkyldimethylamine oxides, alkylamido amine oxides and alkoxyalkylamine oxides, particularly preferably from the group of the amine oxides of formula (Ia) or (Ib),

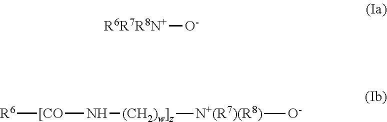

in which R⁶ is a saturated or unsaturated C₆₋₂₂ alkyl group, preferably a C₈₋₁₈ alkyl group, in particular a saturated C₁₀₋₁₆ alkyl group, for example a saturated C₁₂₋₁₄ alkyl group, which is bound to the nitrogen atom N in the alkylamidoamine oxides via a carbonyl amido alkylene group-CO—NH—(CH₂)_{z}-and in the alkoxyalkylamine oxides via an oxaalkylene group-O—(CH₂)_{z}—, where z in each case stands for a number from 1 to 10, preferably 2 to 5, in particular 3,
R⁷ and R⁸ are, independently of one another, a C₁₋₄ alkyl group, which is optionally hydroxy-substituted, such as a hydroxyethyl group, in particular a methyl group.
29. The washing method according to one of the preceding points, wherein the surfactant in step e) is selected from the group of amine oxides, preferably from the group of coco alkyl dimethylamine oxide, myristyl dimethylamine oxide, cetyl dimethylamine oxide, lauryl dimethylamine oxide, and stearyl dimethylamine oxide.
30. The washing method according to one of the preceding points, wherein the peroxycarboxylic acid and the surfactant are introduced into the aqueous liquor in a weight ratio of 2:1 to 1:12, preferably 3:2 to 1:10, and in particular 1:1 to 1:8 in step e).
31. The washing method according to one of the preceding points, wherein the peroxycarboxylic acid and the surfactant are introduced into the aqueous liquor within a period of five minutes, particularly preferably of 2 minutes and in particular of 1 minute in step e).
32. The washing method according to one of the preceding points, wherein a polyalkoxylated polyalkylene imine obtained by reacting polyalkylene imines with alkylene oxides, preferably a polyethoxylated polyethylene imine, is introduced into the aqueous liquor in step e).
33. The washing method according to one of the preceding points, wherein the peroxycarboxylic acid and the surfactant are introduced into the aqueous liquor simultaneously in step e).
34. The washing method according to one of the preceding points, wherein the peroxycarboxylic acid and the surfactant are introduced into the aqueous liquor in the form of a mixture in step e).
35. The washing method according to one of the preceding points, wherein no water softener from the group of the polymeric builders, complexing agents, and sequestering agents is introduced into the aqueous liquor in step e).
36. The washing method according to one of the preceding points, wherein the aqueous liquor in step e) has a temperature T₂ of 26 to 45° C.
37. The washing method according to one of the preceding points, wherein the peroxycarboxylic acid and the surfactant are introduced into the aqueous liquor at a point in time of 30 to 99% t_{w}, preferably at a point in time of 50 to 99% t_{w}, particularly preferably at a point in time of 70 to 99% t_{w}, and in particular at a point in time of 80 to 96 t_{w} in step e).
38. The washing method according to one of the preceding points, wherein, in step e), a phosphonate is also introduced into the aqueous liquor, and the weight ratio of peroxycarboxylic acid to phosphonate is preferably 1:2 to 1:20, preferably 1:4 to 1:12.
39. The washing method according to one of the preceding points, wherein the peroxycarboxylic acid and the phosphonate are introduced into the aqueous liquor simultaneously in step e).
40. The washing method according to one of the preceding points, wherein a pH of 7 to 9, preferably of 7.5 to 8.5, is established in the aqueous liquor after introduction of the peroxycarboxylic acid.
41. The washing method according to one of the preceding points, wherein the aqueous liquor is pumped out of the laundry treatment chamber after completion of the main wash cycle at the point in time of 100% t_{w}.

### EXAMPLES

A washing machine (Bosch WAV28E41) was loaded with the test laundry (75% of the nominal loading amount=6.75 kg of a mixed batch of cotton and synthetic textiles in the ratio 2:1), dirt ballast and an evaluable stain monitor (GCS stain set).

70 ml of a detergent gel were then metered directly onto the laundry, and the wash program (cotton, cold, Speed Perfect modifier, 83 min run time, 1400 rpm final spin) was started. The detergent gel had the following composition:

| Active substance | Wt. % |
|---|---|
| Water | 37% |
| C₁₀₋₁₃ alkylbenzene sulfonate | 22% |
| C₁₂₋₁₄ fatty alcohol ether sulfate 2EO | 5.2% |
| C₁₂₋₁₈ fatty alcohol ethoxylate 7EO | 10% |
| 1,2-propanediol | 11% |
| Monoethanolamine | 2.3% |
| C₁₂₋₁₈ fatty acid | 1.8% |
| Trisodium citrate | 4.2% |
| HEDP-Na4 | 1.4% |
| Glycerol | 0.6% |
| Sorbitol | 0.3% |
| Fragrance | 0.3% |
| Remainder | up to 100 |

In washing test V2, 6 g of a bleaching agent dispersion (Eureco LX 17; 17% 6-phthalimidoperoxycaproic acid suspension) and 5 g Marlox RT 64 (C₁₆-18 alcohol having a degree of ethoxylation of 6 and a degree of propoxylation of 4) were additionally metered directly into the washing tank at the start of the main wash cycle.

In washing test E1, 6 g of a bleaching agent dispersion (Eureco LX 17; 17% 6-phthalimidoperoxycaproic acid suspension) and 5 g Marlox RT 64 (C₁₆-18 alcohol having a degree of ethoxylation of 6 and a degree of propoxylation of 4) were additionally metered directly into the washing tank 10 minutes before the end of the main wash cycle.

After completion of the program, the laundry is removed, and the stain monitor is smoothed and evaluated. The result of this evaluation can be found in the following table.

| Stain | V1 | V2 | E1 |
|---|---|---|---|
| Tea | 55 | 65 | 66 |
| Blackcurrant | 54 | 56 | 64 |
| Blueberry | 54 | 60 | 64 |
| Blood (aged) | 33 | 29 | 47 |
| Whole egg/pigment | 52 | 60 | 73 |
| Cocoa | 46 | 55 | 57 |
| Chocolate ice cream | 59 | 64 | 70 |
| Salad dressing (blackened) | 66 | 59 | 71 |
| Olive oil (soot) | 31 | 35 | 46 |
| Sebum (soot) | 34 | 36 | 45 |
| Mayonnaise (activated carbon) | 28 | 36 | 45 |
| Make-up (liquid) | 54 | 55 | 59 |
| Lipstick, red | 47 | 52 | 59 |
| Beef tallow (dyed) | 56 | 49 | 59 |

1. A method for washing textiles in a washing machine, the method comprising:
providing the washing machine with a wash program, the wash program including a main wash cycle having a duration t_{w};
introducing the textiles into a laundry treatment chamber of the washing machine;
introducing an aqueous liquor into the laundry treatment chamber of the washing machine;
introducing a first detergent composition into the laundry treatment chamber of the washing machine at a point in time of from 0 to 10% of the duration t_{w}, the first detergent composition comprising at least one first surfactant; and
introducing a peroxycarboxylic acid and a second surfactant into the aqueous liquor at a point in time of from 11 to 99% of the duration t_{w}.

2. The method of claim 1, wherein the wash program further includes at least one rinse cycle and at least one spin cycle.

3. The method of claim 1, wherein the duration t_{w} is from 15 to 400 minutes.

4. The method of claim 1, wherein the peroxycarboxylic acid is selected from the group consisting of monoperoxycarboxylic acids, diperoxycarboxylic acids, monoperphthalic acids, diperphthalic acids, monoperterephthalic acids, diperterephthalic acids, and imidoperoxycarboxylic acids.

5. The method of claim 4, wherein the peroxycarboxylic acid is 6-phthalimidoperoxycaproic acid (PAP).

6. The method of claim 9, wherein the peroxycarboxylic acid is in an amount of from 5 to 45 wt. % based on the total weight of the mixture.

7. The method of claim 1, wherein the second surfactant is different from the at least one first surfactant.

8. The method of claim 1, wherein the second surfactant comprises a non-ionic surfactant.

9. The method of claim 1, wherein the peroxycarboxylic acid and the second surfactant are introduced into the aqueous liquor in the form of a mixture.

10. The method of claim 1, wherein the peroxycarboxylic acid and the second surfactant are introduced into the aqueous liquor at a point in time of from 30 to 99% of the duration t_{w}.

11. The method of claim 1, wherein the washing machine is a household washing machine.

12. The method of claim 1, further comprising activating the wash program.

13. The method of claim 3, wherein the duration t_{w} is from 60 to 180 minutes.

14. The method of claim 4, wherein the peroxycarboxylic acid is selected from the group consisting of performic acid, peracetic acid, decanedioic acid, and dodecanedioic acid.

15. The method of claim 6, wherein the peroxycarboxylic acid is in an amount of from 10 to 30 wt. % based on the total weight of the mixture.

16. The method of claim 8, wherein the non-ionic surfactant is selected from the group consisting of alkoxylated primary C₈₋₁₈ alcohols.

17. The method of claim 16, wherein the non-ionic surfactant is selected from the group consisting of ethoxylated primary C₈₋₁₈ alcohols having a degree of ethoxylation≥4 and the ethoxylated and propoxylated C₈₋₁₈ alcohols having a degree of ethoxylation≥4 and a degree of propoxylation≥2.

18. The method of claim 17, wherein the non-ionic surfactant is selected from the group consisting of ethoxylated primary C₁₂₋₁₄ alcohols having a degree of ethoxylation≥6 and the ethoxylated and propoxylated C₁₆₋₁₈ alcohols having a degree of ethoxylation≥4 and a degree of propoxylation≥2.

19. The method of claim 10, wherein the peroxycarboxylic acid and the second surfactant are introduced into the aqueous liquor at a point in time of from 80 to 96% of the duration t_{w}.

20. The method of claim 1, further comprising pumping the aqueous liquor out of the laundry treatment chamber after completion of the main wash cycle.
